(19) United States
(12) Patent Application Publication
(10) Pub. No.: US 2006/0026097 A1
(43) Pub. Date: Feb. 2, 2006

(54) Method and apparatus for verifying a financial instrument

(75) Inventor: Stanton Kee Nethery III, Emeryville, CA (US)

Correspondence Address: DIEDERIKS & WHITELAW, PLC, 12471 Dillingham Square, #301, Woodbridge, VA, 22192, US

(73) Assignee: Kagi, Inc.

(21) Appl. No.: 10/902,046

(22) Filed: Jul. 30, 2004

(51) Int. Cl. G06Q 40/00

(52) U.S. Cl. 705/40

(57) ABSTRACT

An apparatus and method for verifying a customer's legitimacy to use a payment instrument based on access to financial account information provided by the instrument issuer is disclosed. A seller accepts details about goods and services to be delivered, and information about a payment instrument to be used in a purchase by a customer. More specifically, a merchant accepts information about a financial account from the customer including the account's billing address and the account's telephone number associated with the billing address. The merchant obtains a verified billing address from the financial institution holding the financial account by using an address verification system (AVS) and a verified physical address by performing a reverse telephone number query against a reverse telephone number database. The merchant then compares the verified billing address to the verified physical address. For further security the merchant can call either the telephone number provided by the customer or the numbers obtained from the reverse look up or AVS. The number may be called with an interactive voice system and ask questions about the transaction to verify that the customer has indeed made the transaction. Regardless of whether the telephone number provided by the “customer” is at the billing address or not, if a person commits fraud they gave a phone number where they can be reached and that phone number provides a link to the frauder which makes it easier to locate and prosecute them. Just the presence of such a link will deter some frauders.

### BACKGROUND OF THE INVENTION

1. Field of the Invention

The present invention is generally directed to methods of carrying out financial transactions and more particularly transactions involving transfer of funds from credit card, debit card or electronic fund account to a seller's account during remote business transactions.

2. Discussion of the Prior Art Increasingly buyers and sellers involved in commerce are turning to the internet to conduct their business electronically in a relatively fast and quick manner. The internet is particularly attractive to buyers because it provides a vast knowledge base from which they can research and find information about perspective purchases of various goods. Time can be saved because the consumer does not have to travel to various places such as a library or store to obtain information regarding the various goods to be purchased. Indeed, the entire process of shopping for goods and services can be completed using a personal computer at one's home so long as the computer is connected to a network such as the internet. As time has passed, new opportunities for shopping via personal computer have increased as more and more people gain access to the internet and more and more businesses provide services on the internet.

Likewise, using the internet for commerce is extremely attractive to businesses as they can provide the same type of information that was traditionally provided through catalogs and other advertising at much lower cost. Furthermore, transactions can occur between customers and sellers in a similar manner as was usually done at a check out stand in a store. Indeed, in the case of all digital products, such as computer software, videos, music or funds transfer, the goods or services themselves can be delivered through the internet and payment can be received through the internet so that the entire transaction occurs through a computer network without the consumer or merchant ever actually meeting in a store. This method of doing business provides tremendous cost savings to the manufacturers and sellers. Even items that have to be physically shipped can benefit from this form of commerce. Once a customer has browsed through a merchant's web site and selected various goods or services that they wish to purchase, the merchant simply needs to verify the use of the payment instrument and then ship the goods to the customer. The verification of payment step has lead to the most problems because of the untrustworthiness of the verification process and because the verification process often identifies legitimate users as fraudulent users. This state of affairs has caused businesses to restrict commerce on the internet.

One of the reasons that the vast number of merchants already using such networks have trouble increasing sales volume on these networks is the inherent difficulties involved with customers paying for their purchases. The problem facing merchants is how do they determine that a payment instrument and its associated financial data actually belongs to the customer attempting to use the instrument in a remote purchase. Indeed although the above discussion has been related to commerce on the internet, all remote transactions have similar problems with fraud. For example mail order merchants who accept orders over the telephone and ship goods by mail also have trouble determining if a customer and the customer's account are legitimate.

The number one issue of all re-sellers is sales. The second priority is avoiding fraud. In cases of fraud, in order to avoid financial loss when a customer repudiates a transaction, a merchant must prove that goods were actually delivered to the customer. Unfortunately, given the skillfulness of today's fraud rings and the lack of response from financial institutions to worldwide fraud, merchants are on the losing end of this battle. Large fraud rings can intercept packages of goods on route and the merchant will loose any dispute with the bank should a customer repudiate usage of the card or deny accepting delivery of the goods.

Credit card fraud is pretty easy to perpetuate since all a customer (or frauder) needs to complete a transaction is to supply a credit card number and an expiration date. The question asked by every merchant when accepting a card not present transaction, i.e., a transaction in which the merchant cannot inspect the physical card, is whether the person supplying the credit card information is the true holder of the card. The credit card companies (Visa, Mastercard, American Express, etc.) have instituted fraud protection measures such as the Address Verification System (AVS), a Security Code printed on the card, and other similar protections. Used by themselves these fraud protection measures are inadequate. Credit cards used at a restaurant for example, are handled by employees who have opportunity to gather enough data from the card itself to negate these security measures. Even the AVS system can be defeated and is not available internationally. With the advent of the Internet, if one knows the card holder name and a city where the card was collected, it is a trivial matter to obtain the relevant street address information which could be provided as the correct AVS information. The security code printed on credit cards is global but it is visible on the back of the credit card. Any merchant employee who holds the card long enough to gather the card number can also gather the security code.

In the case of digitally shipped goods such as music, data, or downloaded software, the associated transfer of funds from one instrument to another (a credit card transaction), is considered “card not present.” In such a case, a legitimate card holder can always initiate a charge back at any point and typically the merchant loses such a dispute. Therefore the current credit company fraud protection measures are typically not enough by themselves to protect against fraud for merchants who accept cards where the card itself cannot be seen. The standard credit card fraud prevention measures must be combined with other secondary verifications in order to reduce fraud for online or card not present transactions

Given this state of affairs, it becomes very important to a merchant to be able to verify that the user of an instrument is the legitimate card holder before shipping the ordered goods. With such proof, the merchants would have a more powerful argument when a card holder calls the issuer to claim fraud and initiate a charge back

One proposed solution to this problem of course is that a potential purchaser can provide a merchant with a credit card, debit card, or funds account number, which is transmitted over the network or by the telephone. But the problem still exists that the validity of the presenter is questionable because the merchant cannot cross check the instrument's authenticity and usage restrictions. For example, the merchant cannot check the name on the account verses the user's identity. Thus these mechanisms do not address the problem of a customer using a stolen credit, debit or funds card. As such, a dishonest person could use credit card data that was stolen and present it at the merchant's network site or over the telephone. Even if the merchant is using all available anti-fraud systems provided by the instrument's issuer and some proprietary or third party anti-fraud systems, the merchant would not realize they were dealing with stolen card data. Only after the goods were shipped, and delivered and a significant time period had past, would the merchant realize that the wrong person used the credit card data. In the case where credit, debit or funds account number was stolen, thousands of dollars can be lost to the dishonest party who obtains the data and completes numerous fraudulent transactions. Not until the account is canceled can the havoc be stopped. The true cost of this crime can only be counted after the dust settles. In the end, the issuer of the credit, debit or funds account are ultimately accountable for the lost moneys because they self insure themselves and their members against fraud to promote safety of the instrument to customers. If the dishonest party is a single individual, the lawful merchant may be held liable for the money. If the dishonest party is a merchant and is in league with users of stolen instrument data, the dishonest merchant usually will close up shop long before the issuer is able to reclaim the money lost. Since the issuer does not hold a legitimate account holder liable, the issuer is responsible for the lost money. Thus, in the case of a lawful merchant, the lawful merchant retains the responsibility of verifying legitimacy of the card presenter to protect themselves from dishonest persons using stolen instrument data.

Therefore, there exists a need in the art for a method and apparatus which will allow a merchant or other recipient of funds from a payment instrument's issuer to verify the legitimacy that the shopper or customer is the true payment instrument holder or establish a way to track down a “customer” if the “customer” turns out to be a fraudulent user.

### SUMMARY OF THE INVENTION

In general, the invention is directed to a method of verifying ownership of credit cards, debit numbers, bank accounts etc. More specifically, a credit card, debit number or bank account used by a customer can be verified while a purchase is being made so that illegal transactions and fraud can be avoided. The goods may then be shipped to the customer.

In a first embodiment a customer is asked for a phone number at the billing address of the credit card. A billing address may be verified by a bank using an Address Verification System (AVS). After the bank verifies the billing address data a reverse phone number query is performed against a reverse phone number database. The results of such query will return various parts of the physical address location associated with the phone number. This data is then compared to the information obtained from the AVS. Such a system allows the merchant to perform stringent fraud prevention. While it is true that a potential frauder with AVS information acquired on the internet could also utilize the same directory information to acquire a valid phone number for that location most frauders will not have taken the extra step to obtain the phone number. Although AVS data is now typically stolen along with the credit card data or acquired from the knowledge of the customer, the phone number is not typically being provided with the stolen credit card number. Only someone who know the true owner of the credit card, or knows the owner's name and can access the Internet, would know the phone number of the billing address.

In an alternative embodiment fraud prevention is performed by having a computerized automated caller, typically referred to as an Interactive Voice Response System (IVR), call the phone number derived from information provide by the customer and require the person who answers the phone to answer one or more questions about the purchase. The phone number can be the one directly provided by the customer or the one determined by the AVS system or by the reverse phone number lookup database. Proper responses to the IVR system would imply that the owner of the card has indeed placed an order with the merchant.

While each of the above methods is described individually, it should be noted that a system might include various combinations of the individual embodiments. For example if the reverse phone number matches the AVS data, the odds are high that the person who answers the phone will be someone in the household of that customer. Proper responses to the IVR system would imply that the owner of the card presumably located at the billing address has indeed placed an order with the merchant. Regardless of whether the telephone number provided by the “customer” is at the billing address or not, if a person commits fraud they gave a phone number where they can be reached and that phone number provides a link to the frauder which makes it easier to locate and prosecute them. Just the presence of such a link will deter some frauders.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a diagram of a system with computers interconnected by the internet for a product sale or purchase in accordance with a first preferred embodiment of the invention;

FIG. 2 is a block diagram illustrating in more detail the first preferred embodiment of the invention shown in FIG. 1;

FIG. 3 is a flow chart of a computer procedure employed by the seller's computer according to a first preferred embodiment of the invention; and

FIG. 4 is a flow chart of a computer procedure employed in the seller's computer in the system of FIG. 1 according to a second preferred embodiment of the invention.

### DETAILED DESCRIPTION OF THE PREFERRED EMBODIMENT

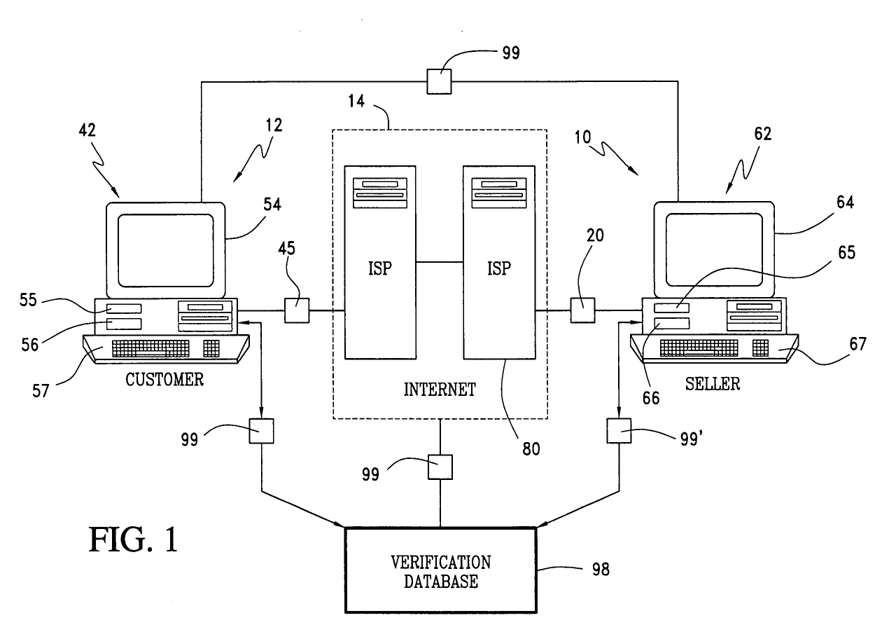

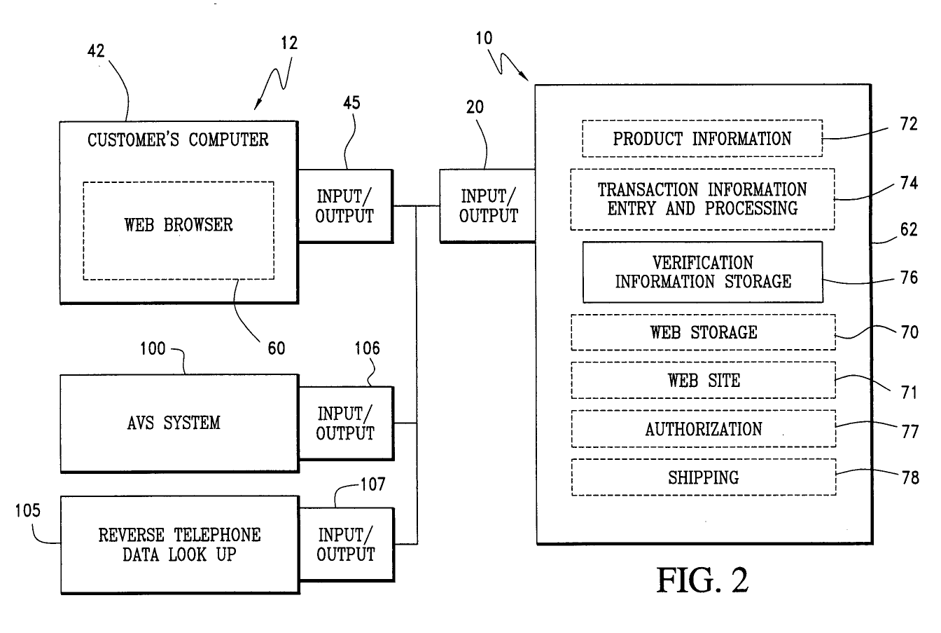

As shown in FIG. 1, a system for handling purchase orders and payments using an electronic communications link in accordance with a first preferred embodiment of the present invention includes a seller's computer system 10 which can be selectively called upon by one or more customer computer systems 12 over an electronic communications link such as the internet 14. As illustrated in FIGS. 1 and 2, seller's computer system 10 is formed of one or more computers and includes an input-output unit 20 for transmitting and receiving digital information to or from the internet 14 and indirectly to a customer's computer 42. Likewise, a customer's computer 42 is also set up to contact the internet 14 through an input-output unit 45. The customer's computer 42 typically has a monitor 54, a central processing unit 55, some type of memory 56 and an input-output unit such as a keyboard 57. Typically when in use, customer's computer 42 would have some type of operating system such as Macintosh, Unix or Windows which would run the basic operations of the computing machine. Additionally, specialized applications such as a web browser 60 would be used to interpret the various protocols of internet 14 into an understandable interface for a computer user, namely the customer.

In a similar manner, a seller's computer 62 may be formed of one or more computers, having one or more monitors 64, a central processing unit 65, some type of memory 66 and an input-output device such as a keyboard 67. Additionally, various applications such as a web server 70 and/or specialized applications that form a website 71 providing information regarding the seller's products 72, and additional applications designed to process financial transactions 74 and/or provide an information storage database 76 for remembering and storing various bits of information regarding the various customers visiting the seller's website 71. Further, the seller's computer has the programming to compare inputted data 77 and authorize shipping of goods 78. The authorization software may also access other authorization systems.

Although in theory the seller's computer could be part of any data network, most preferably the seller's computer system 10 is connected to the internet 14 or an internet service provider (ISP) 80 by a high speed integrated service digital network (ISDN), a T-1 line, a T-3 line or any other type of communication system with other computers or ISP's which typically form the internet 14. Seller may communicate with verification database 98 using the internet 14. Alternatively, the customer and seller may contact each other by separate communication mechanisms 99 and 99′. Such communications could be by telephone, by talking person to person, or any other form of communication that is common in mail order catalog businesses that take orders over the telephone and ship the goods to customers by mail. As seen in FIG. 2, the verification database may be an Address Verification System (AVS) 100 or a reverse telephone look-up 105, each having an input, output device 106, 107.

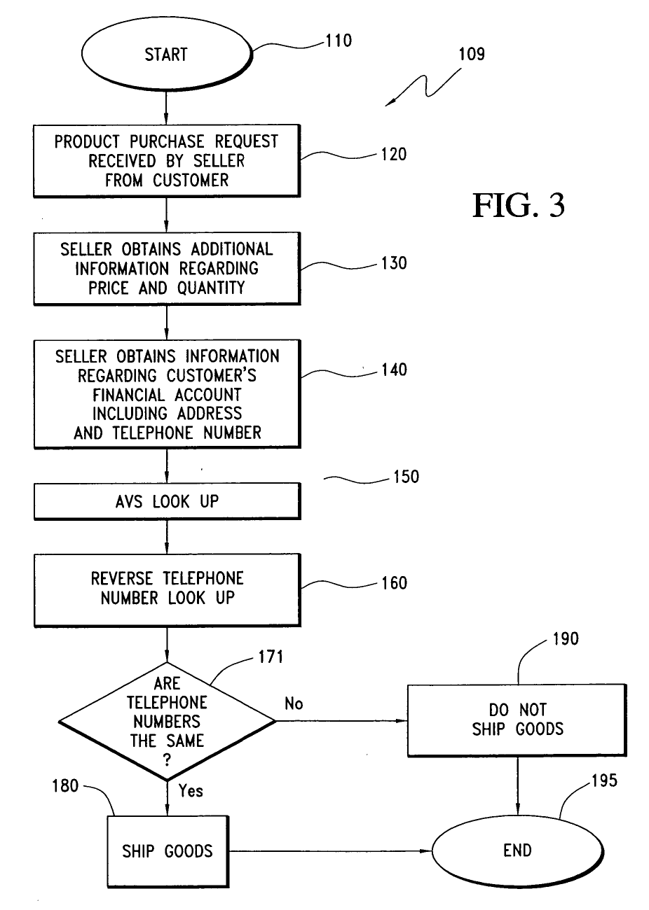

The operation of the seller's computer system 10 will now be described with reference to FIG. 3 which shows a flow chart 109 indicating the various steps of the process. Initially, the customer, by use of a browser 60 or other communication system, contacts the seller's computer 62 and obtains product information 72 from the seller's website 71 or any other source which could be from any website, for example, the product's original manufacturers website. Generally, during this stage, the customer might use several websites on the internet 14 to obtain both price and quality information regarding particular goods. Often, a seller's website 71 will present a customer with several choices by means of the browser interface 60 to aid the customer in determining the various models, types and qualities of particular goods, along with various prices. Additional links may be provided to other web pages which provide further information on each product.

If, after reviewing this information, the customer desires to purchase one or more products reviewed by browser 60, in step 120, the customer enters a product purchase request which is sent over the internet 14 from the customer's computer 12 to the seller's computer 10. The seller's computer 10 then, in step 130, receives additional information regarding the request including the type and quantity of goods to be purchased, along with the price of those goods. Further information regarding the customer is obtained in step 140, such as a shipping address, customers financial account information, billing address, telephone number and other personal information. Such a transaction can be in the form of a series of questions which are answered by the customer or, alternatively, everything can be entered on a form which is then sent in one transmission. If the form is incorrectly filled out, the seller's computer 10 will query the customer regarding the additional information needed. Alternately, the customer may initiate the transaction by telephone and a service representative of the seller will enter the information into the seller's computer 62.

In step 150, the billing address may be verified by a bank using the AVS 100. After the bank verifies the billing address, a reverse number query is performed against the reverse phone number database 105 at step 160. This address data is then compared at 171 to ensure the information obtained from the AVS 100 matches the address information from the reverse telephone number look-up data 105. It is important to note that any information obtained in system 140 from the customer may also be verified directly verses either the AVS system 100 or the reverse phone lookup system 105. If the information is matched as in step 171, then the method proceeds to step 180 where the goods are shipped. Otherwise, the goods are not shipped in step in step 190. And finally, the process ends at step 195.

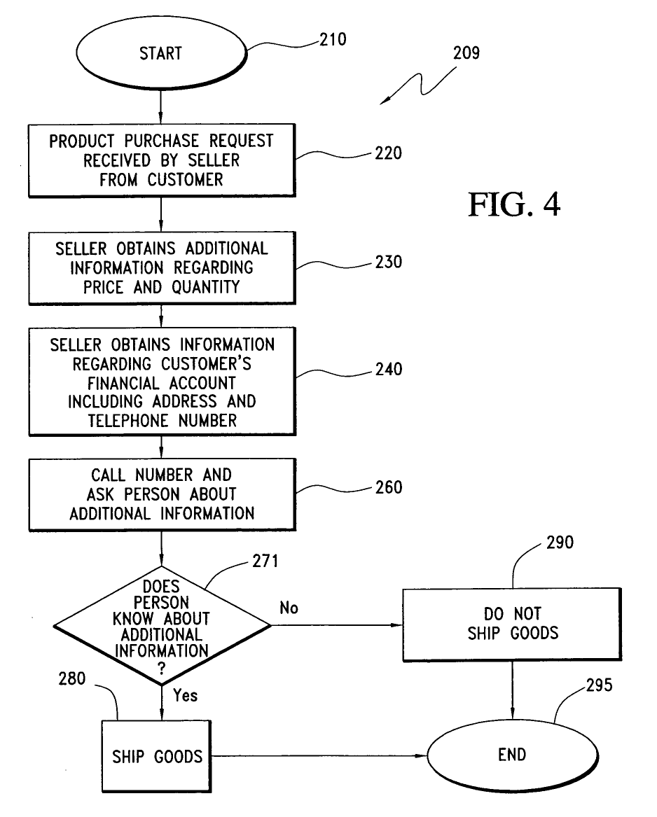

Turning now to FIG. 4, a similar process is outlined in flowchart 209 when once again a customer desires to purchase one or more products reviewed by a browser 60, in step 220. The customer enters a product purchase request which is sent over the internet 14 from the customer's computer 12 to the seller's computer 10. The sellers computer 10 then, in step 230, receives additional information regarding the request including the type and quantity of goods to be purchased along with the price of those goods. Further information regarding the customer is obtained in step 240, such as shipping address, customer's financial account information, billing address and telephone number and other personal information. Such a transaction can be in the form of a series of questions which are answered by the customer or, alternatively, everything can be entered on a form which is then sent in one transmission. If the form is incorrectly filled out, the seller's computer 10 will query the customer regarding the additional information needed. Alternatively, the customer may initiate the transaction by telephone and a service representative of the seller will enter the information into the seller's computer 62. Optimally at this point, the system could perform the same security measures as in steps 150 and 160 described above.

In step 260, the number given by the customer is called and the person answering the phone is asked about the additional information obtained in step 230 regarding the price and quantity being purchased during the transaction. Such a call may be made by an interactive voice response system (IVR). The responses given by the person are compared in step 271 to determine if the person knows about the additional information obtained in step 230. If the person does know about the additional information, the method proceeds to step 280 and the goods are shipped and finally, to step 295 where the process ends. Alternatively, if the person does not know about the additional information, the goods are not shipped, as shown in step 290.

It should be noted that such a method will allow for payment to be made by various instruments such as credit card, check or electronic funds transfer. For example, in the case of credit card transactions, the purchaser name, address, telephone number, credit card and expiration date might be obtained to verify sufficient information to have the transaction go forward. The additional verification described may then take place before payment is processed. In a similar manner, information from a check can be provided and the computerized check approval bureau can be contacted to determine whether or not the check is valid even before the current verification method is used.

Indeed, as noted above given these types of financial instruments, it is envisioned that the system may be used in various ways including any time a merchant is transferring money from instrument to instrument, such as with cash advances via the internet or charging an electronic stored value as in Quasi Money implementations in the micro-commerce area. Additionally, the method may be used for sales in a card not present environment such as online, phone, or mail order, where the seller cannot afford fraud or suspects fraud and wants to rule out such behavior.

Such a system would also provide a benefit where a merchant would otherwise reject good sales thinking that the customer is fraudulent. For example, if the merchant's normal system rejects the customer, the customer could then be asked to answer the questions according to the above described method so that the customer could be considered once again legitimate. Such a system could also be used in any online gambling site where a user needs to be verified as a legitimate card holder because the seller is giving money to the user and if the user is a defrauder the website looses money even before any goods may or may not be shipped due to the nature of gambling.

Although described with reference to a preferred embodiment of the invention, it should be readily understood that various changes and/or modifications may be made to the invention without departing from the spirit thereof. Therefore, it should be understood that the invention is only intended to be limited by the scope of the following claims.

I/we claim:

1. A method of verifying financial account information of a customer in connection with a business transaction comprising the steps of:
accepting information about a financial account from the customer including the account's billing address and the account's telephone number associated with the billing address;
obtaining a verified billing address from the financial institution holding the financial account by using an address verification system;
obtaining a verified physical address by performing a reverse telephone number query against a reverse telephone number database;
comparing the verified billing address to the verified physical address; and
calling a telephone number derived from information provided by the customer.

2. The method according to claim 1 further comprising the additional step of accepting additional information about the business transaction.

3. The method according to claim 2 wherein in the step accepting additional information the additional information includes price and quantity of the goods to be sold.

4. The method according to claim 2 including the additional step of asking person answering phone one or more questions about the additional information and comparing the answers given to the additional information.

5. The method according to claim 2 further comprising the additional step of asking the questions using an interactive voice response system.

6. The method according to claim 2 further comprising the additional step of continuing with the business transaction.

7. The method according to claim 2 further comprising the additional step of continuing with the business transaction and shipping the goods to the billing address.

8. A method of verifying financial account information of a customer in connection with a business transaction comprising the steps of:
accepting information about a financial account from the customer including the account's billing address and the account's telephone number associated with the billing address;
obtaining a verified billing address from the financial institution holding the financial account by using an address verification system;
obtaining a verified physical address by performing a reverse telephone number query against a reverse telephone number database; and
comparing the verified billing address to the verified physical address.

9. The method according to claim 8 further comprising the additional step of accepting additional information about the business transaction.

10. The method according to claim 9 wherein in the step accepting additional information the additional information includes price and quantity of the goods to be sold.

11. The method according to claim 8 further comprising the additional step of continuing with the business transaction.

12. The method according to claim 9 further comprising the additional step of continuing with the business transaction and shipping the goods to the billing address.

13. A method of verifying financial account information of a customer in connection with a business transaction comprising the steps of:
accepting information about a financial account from the customer including the account's billing address and the account's telephone number associated with the billing address;
accepting additional information about the business transaction;
asking person answering phone one or more questions about the additional information and comparing the answers given to the additional information; and
calling telephone number derived from information provided by the customer.

14. The method according to claim 13 further comprising the additional step of obtaining a verified billing address from the financial institution holding the financial account by using an address verification system.

15. The method according to claim 14 further comprising the additional step of obtaining a verified physical address by performing a reverse telephone number query against a reverse telephone number database.

16. The method according to claim 15 further comprising the additional step of comparing the verified billing address to the verified physical address.

17. The method according to claim 13 wherein in the step accepting additional information the additional information includes price and quantity of the goods to be sold.

18. The method according to claim 13 further comprising the additional step of asking the questions using an interactive voice response system.

19. The method according to claim 13 further comprising the additional step of continuing with the business transaction.

20. The method according to claim 19 further comprising the additional step of continuing with the business transaction and shipping the goods to the billing address.

21. A system for verifying financial account information comprising:
a communications link between a customer and seller;
means for accepting information about a financial account from the customer including the account's billing address and the account's telephone number associated with the billing address and additional information about the business transaction;
means for obtaining a verified billing address from the financial institution holding the financial account by using an address verification system;
means for obtaining a verified physical address by performing a reverse telephone number query against a reverse telephone number database; and
means for comparing the verified billing address to the verified physical address.

22. The system according to claim 21, further comprising an interactive voice response system for calling the phone number provided by the customer and a person answering the phone one or more questions about the additional information and comparing the answers given to the additional information.
